(19) United States
(12) Patent Application Publication
(10) Pub. No.: US 2012/0249400 A1
(43) Pub. Date: Oct. 4, 2012

(54) SIGNAL PROCESSING EYE PROTECTING DIGITAL GLASSES

(75) Inventors: Jean Francois Demonchy, Andernos (FR); Denis Penninckx, Cestas (FR)

(73) Assignee: COMMISSARIAT A L'ENERGIE ATOMIQUE ET AUX ENERGIES ALTERNATIVES, PARIS (FR)

(21) Appl. No.: 13/516,223

(22) PCT Filed: Dec. 20, 2010
(86) PCT No.: PCT/EP2010/070261

§ 371 Date: Jun. 14, 2012

(30) Foreign Application Priority Data
Dec. 22, 2009 (FR) 09 59368

(51) Int. Cl. G09G 5/00

(52) U.S. Cl. 345/8

(57) ABSTRACT

Signal processing digital glasses, for protecting an operator's eyes against an annoying or hazardous light ray forming a light spot comprising at least one camera provided with a focusing optics, a power battery, at least one image reproduction screen capable of being provided in front of the operator's eyes, a unit for processing images received from the at least one camera and driving at least one image reproduction screen, a module for detecting and reproducing the light spot by a distinguishing mark on at least one viewing screen.

### TECHNICAL FIELD

The present invention relates to signal processing digital glasses, for protecting an operator's eyes against a light radiation which can be annoying and/or hazardous, for example a laser radiation.

In the following, to simplify the description, a laser beam will be considered by way of example.

### STATE OF PRIOR ART

French patent FR 2 886 538 provides glasses for protecting an operator's eyes located in the vicinity of one or more light radiation sources, for example of the laser type. They specially comprise:

digital vision glasses, which can be virtual vision glasses having a dual LCD monitor,

at least one video camera,

a control device, which comprises a power supply.

There are protecting glasses in prior art which absorb light at the (colour) wavelengths of lasers, one wants to be protected against, and which thus protect the user from the real reflection of his/her environment. Digital vision glasses from known art enable the scene surrounding the user to be viewed, so that the user can move or work in his environment while viewing the light radiations, whether visible or not, which threaten his eyes integrity. Protecting digital glasses from known art enable invisible colours (infrared, most often, or ultraviolet, sometimes) to be “seen”, which is very interesting to adjust the laser beam which is normally invisible. However, colours reproduced to the operator are changed in this case. Moreover, the laser beam, because of the high brightness of the light radiations, often appears “white” through saturation of the camera. Thus, it is not easy to locate the laser beam in the image. Therefore, it is useful, in devices from known art, to add a specific sensor to “see” light radiations and to display them again in the user's field of view.

One object of the present invention is to solve such a technical problem by providing eye protecting digital glasses for processing the image, by better emphasizing an annoying or hazardous light radiation.

### DISCLOSURE OF THE INVENTION

The invention relates to signal processing digital glasses, for protecting an operator's eyes against at least one laser radiation forming a spot comprising at least one camera provided with a focusing optics and a power battery, characterised in that they comprise:

a camera for detecting the laser radiation(s) which is equipped with a filter centred on the wavelength(s) of the laser(s),

at least one image reproduction screen capable of being provided in front of the operator's eyes,

a unit for processing images received from the at least one camera, which drives each image reproduction screen,

a module for detecting and reproducing each light spot by displaying a distinguishing mark on at least one image reproduction screen.

Each camera can comprise a CCD cell or a CMOS cell.

In an advantageous embodiment, the glasses of the invention comprise two cameras, and two image reproduction screens each corresponding to a camera, each image reproduction screen being capable of being provided in front of an operator's eye.

In a first alternative embodiment, the glasses comprise:

an audio sender and/or transmitter powered by the battery,

a sender and/or a microphone connected to the audio sender and/or transmitter

In a second alternative embodiment, the glasses comprise:

a device for measuring the battery level, and

at least one alarm icon displayable on one or both of the image reproduction screens and/or a sound signal sender.

In a third alternative embodiment, the glasses comprise:

an on-off signal transceiver powered by the battery,

at least one icon displayable on one or both of the image reproduction screens and/or a sound signal sender.

In a fourth alternative embodiment, the glasses comprise:

a video sender and/or transmitter.

In a fifth alternative embodiment, the glasses comprise:

a memory card.

In a sixth alternative embodiment, the glasses comprise:

a cell being sensitive to the light radiation wavelength.

The glasses of the invention enable the image to be processed so as to better emphasize an annoying or hazardous light radiation, for example a laser radiation, by enabling in particular the image to be better interpreted, the laser beam to be better adjusted (for example alignment) and the eye safety to be increased, without having any drawback to the user.

Besides reproducing a working scene in a laser room, the glasses of the invention enable any annoying or hazardous radiation or spot, for example laser, detected by a highlighted display, by a flashing, by an unusual pattern in the environment, for example of the hatching type, or by an unnatural colour (for example pure red) to be materialized.

### BRIEF DESCRIPTION OF THE DRAWINGS

FIG. 1 illustrates a first embodiment of simple vision protecting glasses according to the invention,

FIG. 2 illustrates a second embodiment of protecting glasses according to the invention, with relief reproduction,

FIG. 3 illustrates a first alternative of the second embodiment of the protecting glasses of the invention, with audio transmission,

FIG. 4 illustrates a second alternative of the second embodiment of the protecting glasses of the invention, with power control,

FIG. 5 illustrates a third alternative of the second embodiment of the protecting glasses of the invention, with on-off signal management and sending-reception,

FIG. 6 illustrates a fourth alternative of the second embodiment of the protecting glasses of the invention, with video signal sending-reception,

FIG. 7 illustrates a fifth alternative of the second embodiment of the protecting glasses of the invention, with shooting,

FIG. 8 illustrates a sixth alternative of the second embodiment of the protecting glasses of the invention, with materialization of a wavelength beam invisible to the eye.

### DETAILED DISCLOSURE OF THE PARTICULAR EMBODIMENTS

The glasses of the invention have three functions:

an image capture thanks to at least one camera and possibly a further sensor,

an image detection for example thanks to an image processing electronics, and

an image reproduction on at least one image reproduction screen.

These glasses enable an annoying and/or hazardous light radiation to be seen by an operator while protecting himself. If the wavelength makes part of the spectrum sensed by the cameras, the image should be processed to be better emphasized. If it does not make part thereof, a further sensor can be used.

Therefore, there are two cases for image capture:

in the case of a laser the wavelength of which is between visible and near infrared (typically 1064 nm); the cameras, given their bandpass in the light spectrum, are sufficient and their output signal is processed,

in the case of a laser the wavelength of which is located outside the visible range: a third sensor is fitted to the glasses besides the cameras for viewing the working scene: such third sensor is made or selected depending on the wavelength(s) of the laser used and generates a signal which is format-compatible with the viewing cameras. Such signal is processed and then mixed with the signal from the cameras with a reproduction on the image reproduction screens.

Even if the laser wavelength can be detected by the cameras providing viewing of the scene, it could be interesting to add a third camera provided with a filter for the laser wavelength. Consequently, it is very easy to detect the laser beam in the scene.

Two solutions are provided for the image detection and reproduction:

the one has an image processing electronics available which detects through thresholding light overintensities and reproduces them on the video frame,

the other proposes an image processing computer unit (of the “4 sight” type from Matrox) capable of performing the intended function, and which also allows image processing based functions to be further added.

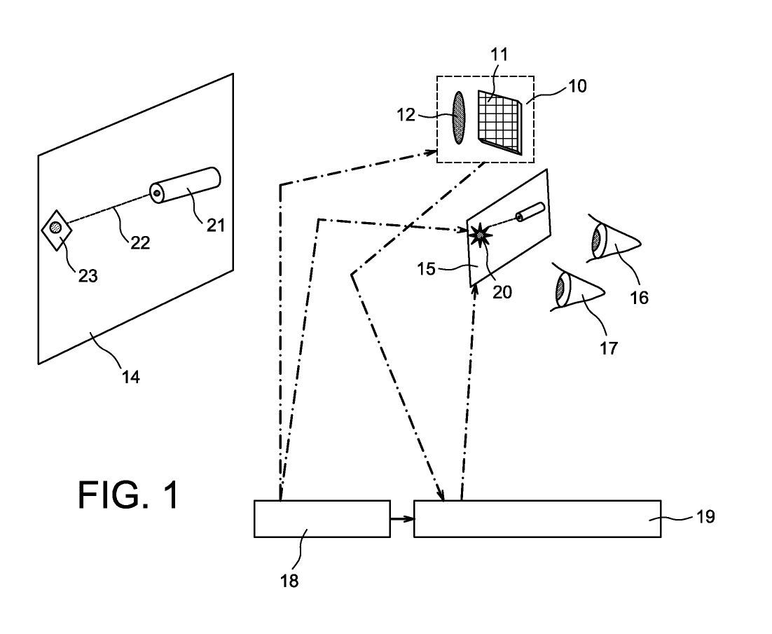

In a first embodiment illustrated in FIG. 1, the protecting digital glasses of the invention are simple vision glasses, which comprise:

a camera 10 including a CCD or CMOS cell 11 and a focusing optics 12, which is directed to a scene 14 to be viewed, which comprises an annoying and/or hazardous invisible radiation 22, for example a radiation from a laser 21, forming a light spot 23,

an image reproduction screen 15, provided in front of the operator's eyes 16 and 17,

an image processing unit 19 which receives the output signals from the camera, and drives the image reproduction screen 15,

a module 20 for detecting and reproducing the light spot 23 by displaying a shape, a colour or any other distinguishing mark, on at least one image reproduction screen,

a battery 18 enabling these different elements to be powered.

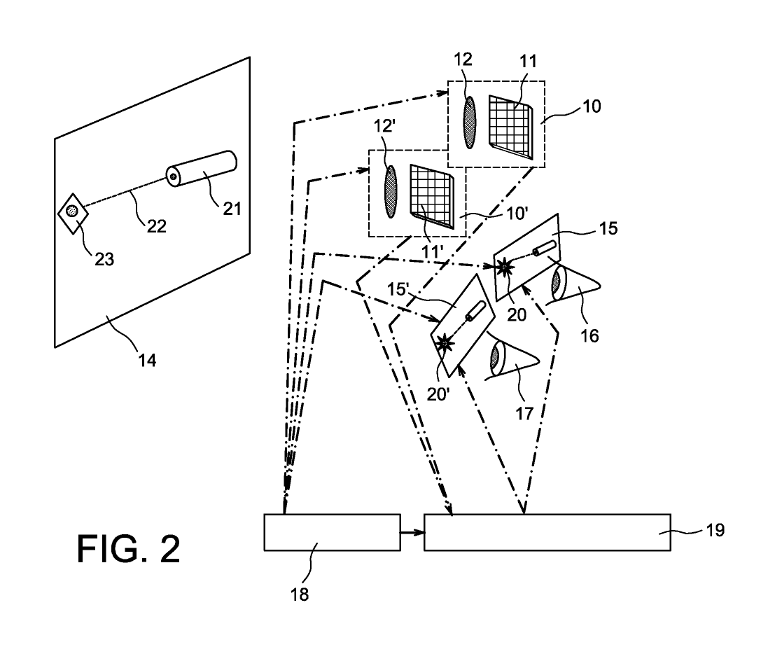

In a second embodiment illustrated in FIG. 2, the protecting digital glasses of the invention are glasses enabling reliefs to be reproduced, which comprise:

two cameras 10 and 10′ each including a CCD or CMOS cell 11 (11′) and a focusing optics 12 (12′), directed to the scene 14 to be viewed,

two image reproduction screens 15 (15′) each corresponding to one camera, respectively provided in front of the operator's eyes 16 and 17,

an image processing unit 19 which receives the output signals from the camera and drives both image reproduction screens 15 and 15′,

two modules 20 and 20′ for detecting and reproducing the light spot 23 by a shape, a colour or any other distinguishing mark,

a battery 18 for powering these different elements.

Different alternatives of this second embodiment of the glasses of the invention are possible, for example:

with audio transmission,

with power control,

with on-off signal management and sending-reception,

with video signal sending-reception,

with shooting.

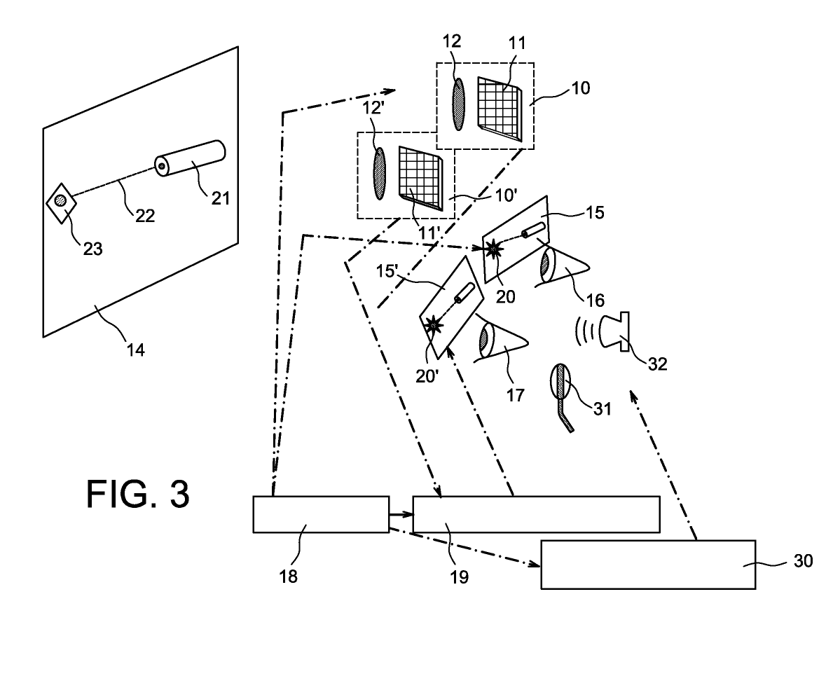

A first alternative embodiment, illustrated in FIG. 3, takes in the elements of the second embodiment and further includes:

an audio sender and/or transmitter 30 powered by the battery 18, and

a microphone 31 and/or a sender 32 which are connected to the audio sender and/or transmitter 30.

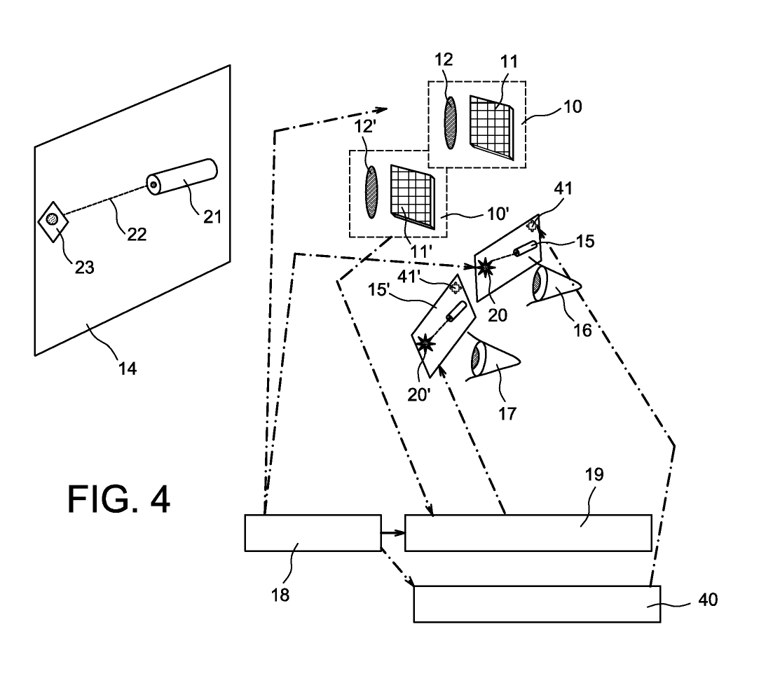

A second alternative embodiment, illustrated in FIG. 4, takes in the elements of the second embodiment and further includes:

a device 40 for measuring the battery 18 level, and

at least one alarm icon 41, 41′ displayable on one or both of the image reproduction screens 10, 10′ and/or a sound signal sender not represented in FIG. 4.

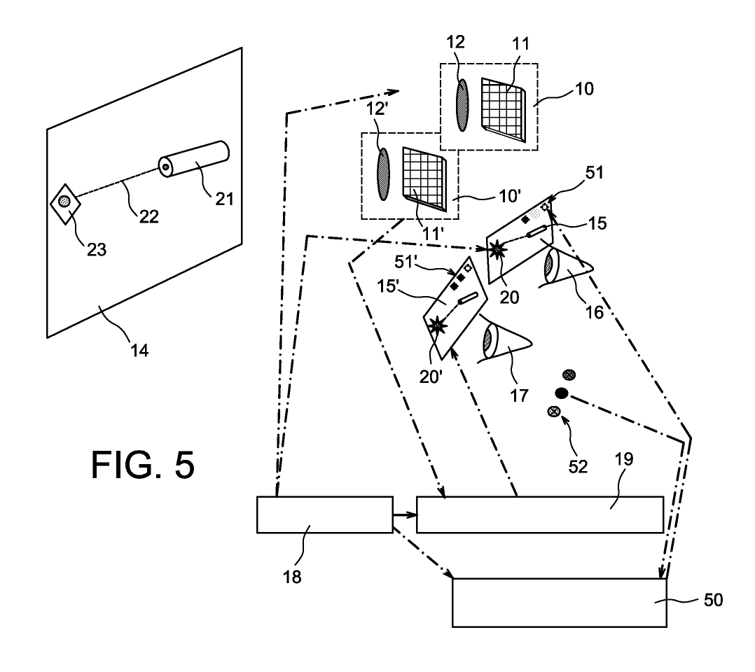

A third alternative embodiment, illustrated in FIG. 5, takes in the elements of the second embodiment and further includes:

an on-off signal transceiver 50 powered by the battery 18,

different sensors 52 connected to the signal transceiver 50,

at least one icon 51, 51′ displayable on one or both of the image reproduction screens 10, 10′ and/or a sound signal sender not represented in FIG. 5.

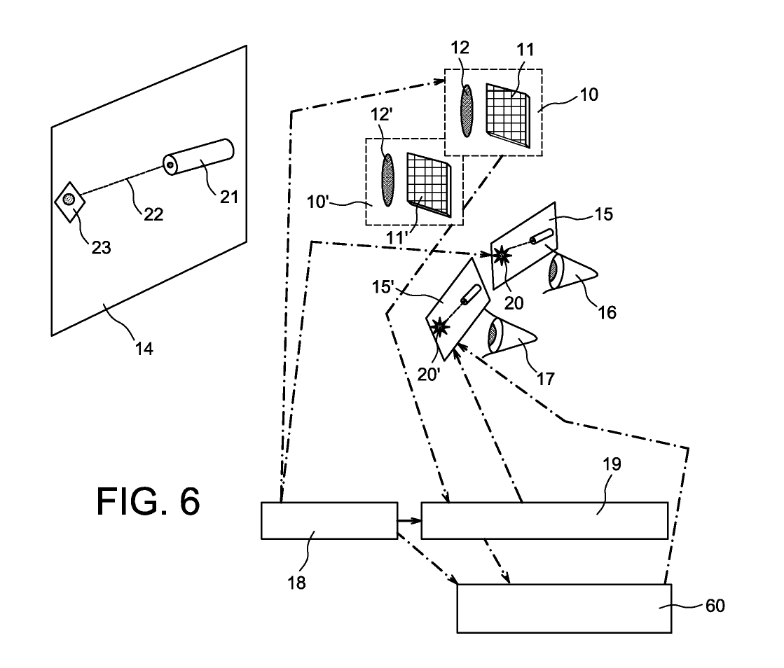

A fourth alternative embodiment, illustrated in FIG. 6, takes in the elements of the second embodiment and further includes:

a video sender and/or transmitter 60, wherein the viewed signal can come from a video receiver (for example with augmented reality) or from the image processing unit 19.

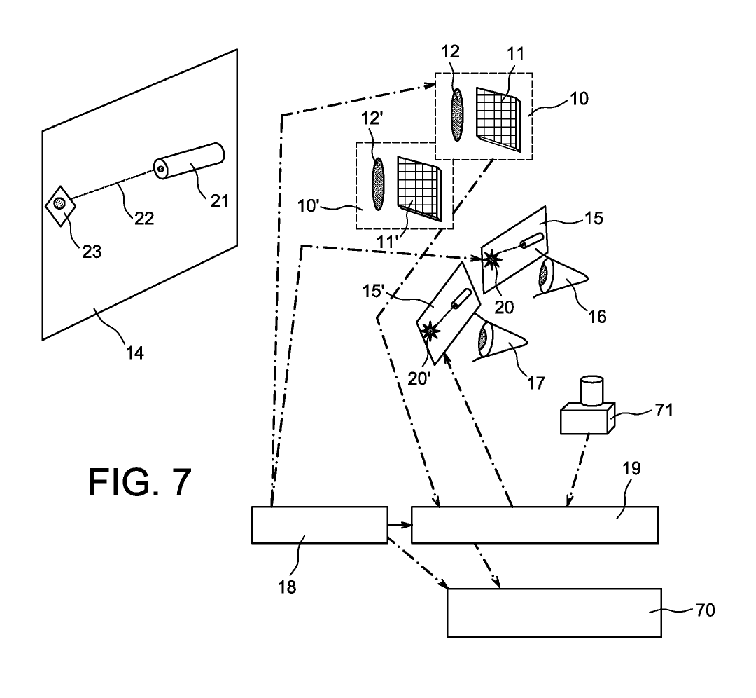

A fifth alternative embodiment, illustrated in FIG. 7, takes in the elements of the second embodiment and further includes:

a memory card 70, for example of the SD (“Secure Digital”) or CF (“Compact Flash”) type,

a shooting control 71, with on-the-flight-image storage.

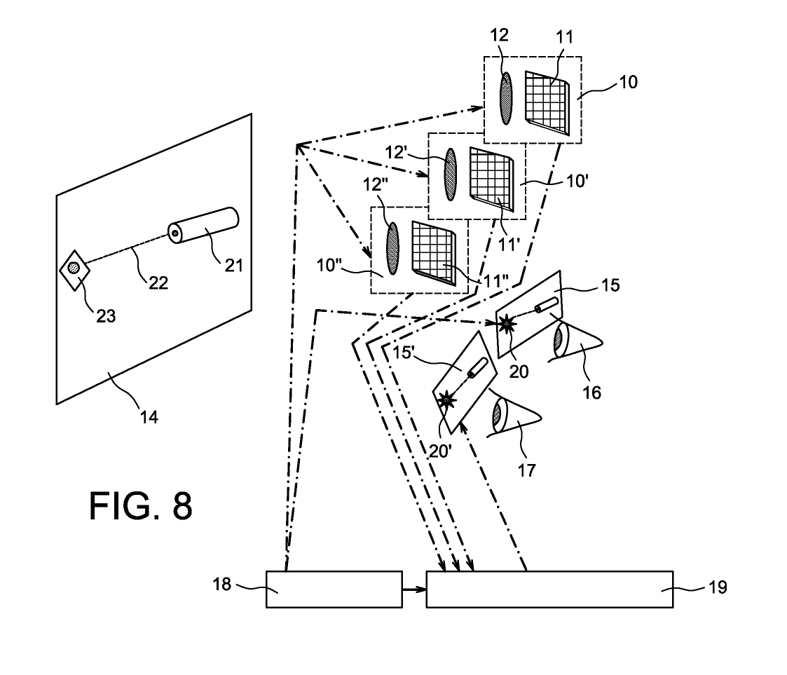

A sixth alternative, illustrated in FIG. 8, takes in the elements of the second embodiment and further includes:
a detection module which is sensitive to the laser beam wavelength to be observed, which can be a camera 10″ including a cell 11″ and a focusing optics 12″.

Exemplary Characteristics and Operation of an Embodiment

1. Characteristics:
a) Stereovision
b) Laser detection by a third camera
c) Monitoring the battery level
d) On-off video sending
e) Shooting

2. Operation:

a) Stereovision

This mode is used to reproduce the environment relief to the user. It imposes integrating two cameras and two viewing screens.

Images sensed by the cameras are transmitted to the viewing screens through a video processor. The cameras are directed such that their point of convergence is at a distance of about 25 cm from the user's head. This distance is selected because it corresponds to the head/hands distance upon carrying out a manual work. The screens are positioned in front of each user's eye. The screens have, for example, an 800×300 resolution. The camera cells have, for example, an 2400×1800 resolution. This resolution, three times higher than the screens resolution enables a good quality image to be reproduced on the screens, even in digital zoom.

b) Laser Detection by a Third Camera

A third camera is placed between both cameras providing the stereoscopic vision for detecting the radiation emitted by a laser whether it is visible or not to the naked eye. The sensitivity spectral range of this third camera is suitable for the laser radiation(s) to be detected. This third camera is equipped with a filter centred on the wavelength(s) of the laser(s) to better distinguish it (them). A thresholding is performed to only recover the most intense radiation which corresponds to the laser. The points detected are for example replaced by a simple unnatural colour (bright red for example). The rest of the image is replaced by a neutral grey. By calculating the intercorrelation between images from the vision cameras and the processed image from the detection camera, the images can be superimposed which are then mixed and then sent to the screens. Thus, the user sees the scene in 3D (three dimensions) with the laser beam(s) materialized.

c) Monitoring the Battery Level

An electronic voltage comparator is provided to the power battery of the “protecting glasses” assembly. Through two <<on-off >> signals, the processor is informed about two battery levels (low: remaining 15 min before recharging, very low: remaining 5 min before recharging). The processor, upon reading this information, displays an alarm icon for the low level on the screens and, furthermore, flashes the display on the screens for the very low level.

d) On-Off Video Sending

The object of the invention is to process the image so as to emphasize the beam or the laser spot to the operator to better interprete the image, enabling the beam to be adjusted (for example alignment) and safety (ocular and else) to be further enhanced.

Besides reproducing a work scene in a laser room, such a system can materialize by a highlighted display, by flashing, by an unusual pattern in the environment (ex: a star) or by an unnatural colour (ex: pure red) any laser beam or spot detected.

Three functions should be fulfilled to achieve this result, the image capture, the detection and the reproduction on the screens.

For detection and reproduction, one solution could be to propose a portable image processing computer unit (for example of the 4sight type from Matrox) capable of carrying out the intended function, but also which allows any other image processing based function addition.

For image capture, there are two cases:
Case of the laser which is visible and up to the near infrared (typically 1064 nm): the viewing cameras are sufficient, given their bandpass in the light spectrum. It is their signal that is processed.
Case of the laser outside the visible range: besides the viewing cameras of the working scene, a third sensor can be fitted to the glasses. This is made or selected depending on the wavelength(s) of the lasers used, and generates a signal which is format-compatible with the viewing cameras. It is this one which is processed and then mixed to the signal from the cameras before reproduction on the screens.

A user fainting detection can be implanted in the glasses (mercury contact, shock or movement detector . . . ). A particular signal is then transmitted.

A “movable emergency stop” is worn by the user. He can actuate it at any time and in any place.

A low battery level detection is implanted. This information besides being emitted to outside environment is locally processed to alert the user.

The reception of these signals results in closing the contacts which are able to control various safety members.

Example:

Extractor opening,

Power switch off,

Materializing the premises where the accident is occurring,

Triggering alarm, sound, remote alarm signals . . . .

The receiver is able to determine who the signals are coming from.

On-off signals can be sent by the environment (PC, automatic terminals . . . ) and are related to alerts.

Example:

Laser ON,

“ammonia” alert,

Fire alarm . . . .

These sendings are of three types:

General (to all the users),

Regional (to a group of users),

Individual (to one user).

Upon receiving, they can take one or several forms for the user:

Colour light indicators in the field of view,

Sound signal,

Flashing of the display,

Video overlay (case of an optional image processing).

These glasses can be equipped with a “full duplex” (free hands) intercom system.

As set out above, if the transmission is hertzian, the digital technology offers more easily the possibility to encrypt data and therefore to meet some confidentiality requirements.

The glasses can be provided with a video sending system. Such data are then transmitted to a monitoring PC.

They have multiple uses:

monitoring an isolated worker,

performing the work to be carried out by one or more experts,

recording everything that is said and done for preserving the knowledge and storing procedures.

The video received from the user can further be processed and/or mixed with other information signals, and then be retransmitted to the protecting glasses before retransmission-displaying on the viewing screens.

Examples:

a) Processings:

Movement recognition (monitoring a hostile environment),

Detection of light overintensity spot (laser beam).

b) Mixing:

Displaying information (alerts, battery level, time . . . ),

Displaying instructions (list of operations . . . ),

Materialization of spots, path of light beams.

e) Shooting

By actuating a control, the user can store images he/she views on his/her screens in a SD (“Secure Digital”) type card for example.

1. Signal processing digital glasses, for protecting an operator's eyes against at least one laser radiation comprising:
at least one camera provided with a focusing optics and a power battery,
a unit for processing images received from the at least one camera, which drives at least one image reproduction screen,
at least one screen for reproducing such images, which is capable of being provided in front of the operator's eyes,
such digital glasses being characterised in that they comprise:
a camera for detecting the laser radiation(s) which is equipped with a filter centered on the wavelength(s) of the laser radiation(s),
a module for detecting and reproducing such images on at least one of the image reproduction screens, with light materialization of the path of the laser radiation(s).

2. The glasses according to claim 1, wherein each camera comprises a CCD cell.

3. The glasses according to claim 1, wherein each camera comprises a CMOS cell.

4. The glasses according to claim 1, comprising two cameras, and two image reproduction screens each corresponding to one camera, each screen being capable of being provided in front of an operator's eye.

5. The glasses according to claim 4, which comprise:
an audio sender and/or transmitter powered by the battery,
a sender and/or a microphone connected to the audio sender and/or transmitter.

6. The glasses according to claim 4, which comprise:
a device for measuring the battery level, and
at least one alarm icon displayable on one or both of the image reproduction screens and/or a sound signal sender.

7. The glasses according to claim 4, which comprise:
an on-off signal transceiver powered by the battery,
at least one icon displayable on one or both of the image reproduction screens and/or a sound signal sender.

8. The glasses according to claim 4, which comprise: a video sender and/or transmitter.

9. The glasses according to claim 4, which comprise:
a memory card.

10. The glasses according to claim 4, which comprise:
a detection device being sensitive to the light radiation wavelength.
